(19) United States
(12) Patent Application Publication
(10) Pub. No.: US 2007/0279416 A1
(43) Pub. Date: Dec. 6, 2007

(54) Enabling and Rendering Business Components in an Interactive Data Visualization Tool

(76) Inventors: Glenn A. Cobb, Lansing, NY (US); Richard W. Page, Lansing, NY (US); Martin M. Wattenberg, Winchester, MA (US)

Correspondence Address: HOFFMAN, WARNICK & D'ALESSANDRO LLC, 75 STATE ST, 14TH FLOOR, ALBANY, NY, 12207, US

(21) Appl. No.: 11/422,522

(22) Filed: Jun. 6, 2006

(51) Int. Cl. G06T 11/20

(52) U.S. Cl. 345/440

(57) ABSTRACT

The present invention provides a method, system, and computer program product for enabling and rendering business components in an interactive data visualization tool. A method in accordance with the present invention includes: importing a data set into a CBM visualization tool, the data set providing content and attributes related to the components; generating and displaying a CBM map based on the content, the CBM map displaying a plurality of the components; selecting at least one of the attributes via a user interface (UI); and dynamically displaying information regarding each selected attribute on corresponding components of the CBM map.

### FIELD OF THE INVENTION

The present invention generally relates to business processes, and more specifically relates to the enabling and rendering of business components in an interactive data visualization tool.

### BACKGROUND OF THE INVENTION

A Component Business Model (CBM) is a framework that aggregates business activities into non-overlapping components that can be shared across a business or enterprise (hereafter collectively referred to as “business”). A CBM is a logical representation of a business that reveals its essential building blocks. A CBM provides a very powerful technique to investigate and model many different aspects of a business, and provides the visual ability to layer various attributes as heat maps across the components. Components themselves are individual business modules that play a specifically designed role within the business. These components collaborate and integrate seamlessly with each other, networking together to form the entire business. Each component has discrete boundaries, defined by the services that it uses as inputs and offers as outputs, and includes the resources, people, technology and know-how necessary to deliver some value. Components can have attributes, such as cost, revenue, importance to the business, etc.

An illustrative CBM map 10 is depicted in FIG. 1. The rows 12 in the CBM map 10 are defined by actions. The top row 12, “direct,” represents all of those components 14 in the business that set the overall strategy and direction for the business. The middle row 12, “control,” represents all of the components 14 in the business that translate those plans into actions, in addition to managing the day-to-day running of those activities. The bottom row, “execute,” contains the components 14 that actually execute the detailed activities and plans of the business. The columns 16 in the CBM map 10 are business competencies, which comprise business areas with characteristic skills and capabilities, for example, business administration or new business development.

An illustrative business component 14 is depicted in FIG. 2. The component 14 has discrete boundaries, defined by the business services that it offers and the business services it uses. The component 14 includes the resources, people, technology and know-how necessary to deliver some value, and can have attributes, such as cost, revenue, importance to the business, etc. As further depicted in FIG. 3, a business process 18 can be represented as a collaboration among multiple business components 14.

The ability to clearly define a component, its function and its dependency on other components is important to the CBM process. In addition, the ability to dispose a component via attribution is also an important aspect of CBM as a business strategy/architecture tool.

The CBM process can be used to drive facets of a business including, but not limited to:
a) Strategic Alignment—Aligning business capabilities to the overall strategy and identifying differentiating requirements.
b) Ensuring investments are aligned with the overall strategy.
c) Organization integration—Enabling a comprehensive, non-political and non-silo view of the organizational capabilities and creating a single roadmap for integration.
d) Prioritizing transformation initiatives.
e) Creating integrated business and technology transformation roadmaps that are aligned with the overall strategy.
f) Sourcing issues—Identify non-differentiated parts of the business that are better served with shared services or alternate sourcing/partnering arrangements.
g) Technology issues—Creating an underlying technology architecture that leverages the existing investments and builds incremental capabilities to support increased flexibility and responsiveness.
h) Metrics alignment—Ensuring operational metrics exist to support the key areas of the business and are consistent across the business.
i) Other aspects including, for example, structuring operations, aligning business and information technology (IT) strategy, shared services, and process streamlining.

The assembly of information for a CBM map using currently available presentation and spreadsheet programs is tedious and ineffective, making the deployment, manipulation and maintainability of a CBM map very difficult and time consuming. For example, to take a draft CBM map and update the data can require many hours of separate and manual updates to the associated presentation and/or spreadsheet documents, which can be prohibitively slow and costly. Another value of a CBM is the ability to show change based on potential changes or as a result of the compounded effect of multiple attributes being applied to a given CBM Model. These variations require the creation of many versions of the model. Unfortunately, there are no technologies available to support this new approach to business modeling, and conventional techniques and approaches are not flexible or functional enough to support this need.

### SUMMARY OF THE INVENTION

In general, the present invention provides an interactive data visualization tool. The interactive data visualization tool provides a richer, more sophisticated interface for generating and rendering business components in a CBM map for various industries in real time. It provides an extremely dynamic approach which converts static information provided through a document (e.g., a spreadsheet) into a UI which allows for total flexibility and rendering of various views and filters without the need to actually manipulate the underlying data. The interactive data visualization tool allows for asset reuse (already assembled industry and enterprise templates), allows for quick editing to tailor towards a target business, allows for quick attribution to drive the various facets of a business, and allows for a full round trip from the loading of the content into the interactive data visualization tool, to a download of the content to enable a user to easily manipulate the information to change the attributes as necessary.

A first aspect of the present invention is directed to a method for rendering components in a component business model (CBM) map, comprising: importing a data set into a CBM visualization tool, the data set providing content and attributes related to the components; generating and displaying a CBM map based on the content, the CBM map displaying a plurality of the components; selecting at least one of the attributes via a user interface (UI); and dynamically displaying information regarding each selected attribute on corresponding components of the CBM map.

A second aspect of the present invention is directed to system for rendering components in a component business model (CBM) map, comprising: a system for importing a data set into a CBM visualization tool, the data set providing content and attributes related to the components; a system for generating and displaying a CBM map based on the content, the CBM map displaying a plurality of the components; a user interface (UI) for selecting at least one of the attributes; and a system for dynamically displaying information regarding each selected attribute on corresponding components of the CBM map.

A third aspect of the present invention is directed to program product stored on a computer readable medium for rendering components in a component business model (CBM) map, the computer readable medium comprising program code for: importing a data set into a CBM visualization tool, the data set providing content and attributes related to the components; generating and displaying a CBM map based on the content, the CBM map displaying a plurality of the components; selecting at least one of the attributes via a user interface (UI); and dynamically displaying information regarding each selected attribute on corresponding components of the CBM map.

A fourth aspect of the present invention is directed to a method for deploying an application for rendering components in a component business model (CBM) map, comprising: providing a computer infrastructure being operable to: import a data set into a CBM visualization tool, the data set providing content and attributes related to the components; generate and display a CBM map based on the content, the CBM map displaying a plurality of the components; select at least one of the attributes via a user interface (UI); and dynamically display information regarding each selected attribute on corresponding components of the CBM map.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative CBM map in accordance with the prior art.

FIG. 2 depicts an illustrative business component in accordance with the prior art.

FIG. 3 depicts an illustrative business process represented as a collaboration among business components in accordance with the prior art.

FIG. 4 depicts an illustrative CBM data visualization process in accordance with an embodiment of the present invention.

FIG. 5 depicts a partial view of an illustrative data source in the form of a spreadsheet in accordance with an embodiment of the present invention.

FIGS. 6-9 depict illustrative CBM maps provided in accordance with embodiment(s) of the present invention.

FIG. 10 depicts an illustrative zoomed-out portion of a CBM map in accordance with an embodiment of the present invention.

FIG. 11 depicts a pop-up window containing information regarding a component of a CBM map in accordance with an embodiment of the present invention.

FIG. 12 depicts an illustrative computer system for implementing embodiment(s) of the present invention.

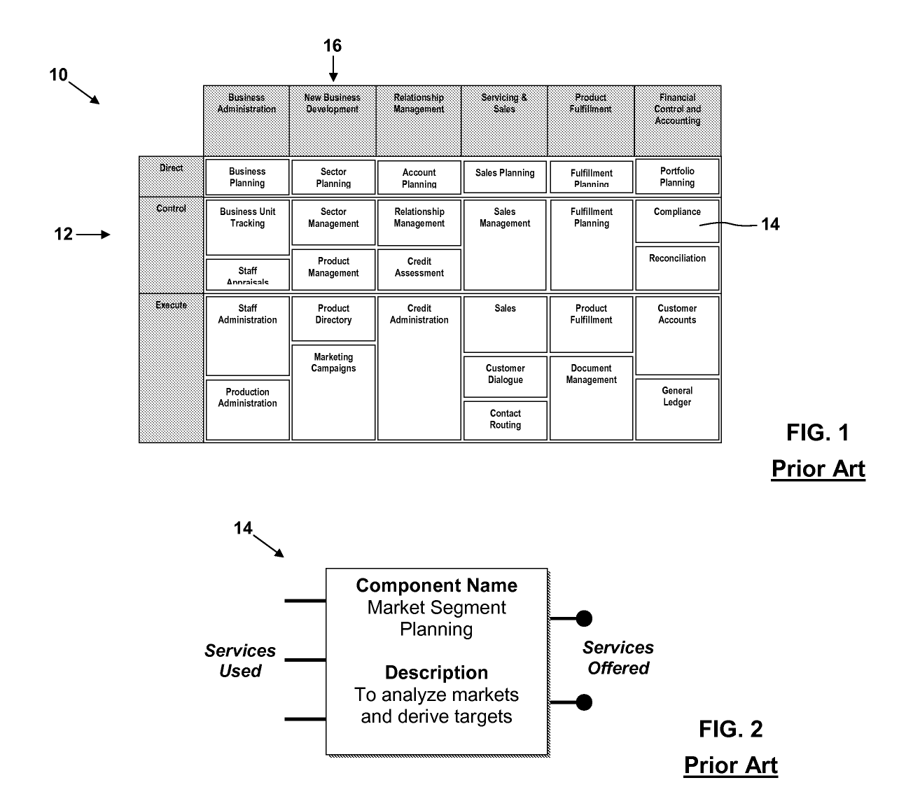

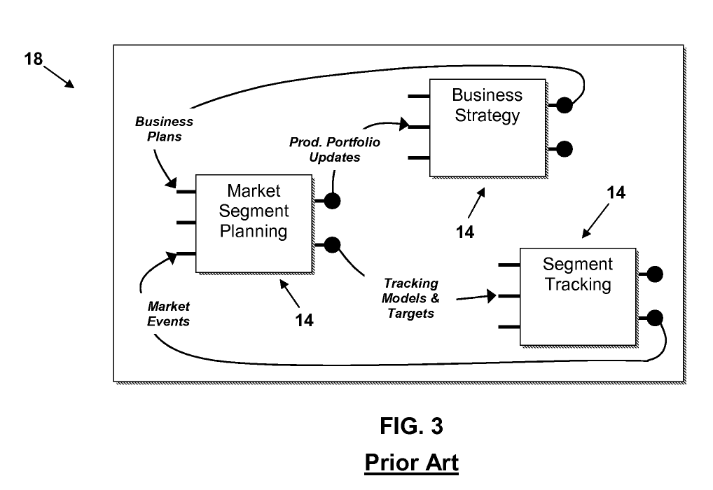

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides an interactive data visualization tool. The interactive data visualization tool provides a richer, more sophisticated, interface for generating and rendering business components in a Component Business Model (CBM) map for various industries in real time. It provides an extremely dynamic approach which converts static information provided through a document (e.g., a spreadsheet) into a user interface (UI) which allows for total flexibility and rendering of various views and filters without the need to actually manipulate the underlying data. The interactive data visualization tool allows for asset reuse (already assembled industry and enterprise templates), allows for quick editing to tailor towards a target business, allows for quick attribution to drive the various facets of a business, and allows for a full round trip from the loading of the content into the interactive data visualization tool, to a download of the content to enable a user to easily manipulate the information to change the attributes as necessary.

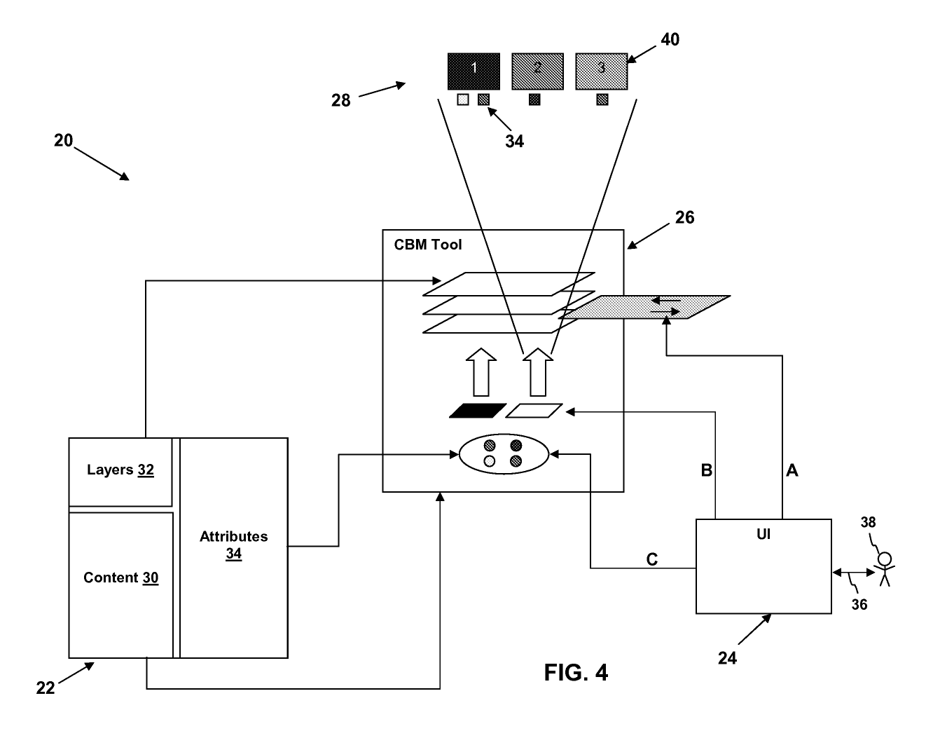

An illustrative CBM data visualization (DV) process 20 in accordance with an embodiment of the present invention is depicted in FIG. 4. The CBM DV process 20 includes a data source 22, a UI 24, a CBM data visualization tool 26, and a resulting CBM data visualization 28 (hereafter referred to as a CBM map 28). The data source 22, which in this case comprises a spreadsheet, provides a data set that is used to drive the CBM DV process 20. Other data sources 22 that can provide the data set in a format (e.g., XML, comma delimited, etc.) that can be imported into and understood by the CBM data visualization tool 26 of the present invention can also be used.

The data set provided by the data source 22 can include, for example, content 30, one or more layers 32, and attributes 34. The content 30, layers 32, and attributes 34 are imported by the CBM data visualization tool 26. Based on user input 36 provided via the UI 24, a user 38 can selectively filter out one or more layers 32, as indicated by arrow A, selectively display components 40 (e.g., based on attributes 34), as indicated by arrow B, and selectively apply attributes 34 to components 40, as indicated by arrow C, to generate a desired CBM map 28. The CBM map 28 typically comprises, for example, components 40 with thermal indicators, and zero or more attributes 34 associated with each component 40.

As the data set is read into the CBM data visualization tool 26 from the data source 22, the CBM data visualization tool 26 parses the information into layers 32 based on the attributes 34 and relationships that have been defined in the data set. The layers 32 of information then create their own indicators and triggers as part of the reading of information such that the actual data feed defines the complete layout of the CBM map 28, user navigation, and the availability of selections. For example, if the data collection efforts captured information for a component 40, such as the necessary lunar phase to support deployment of that component 40 on a scale of no moon, ¼ moon, ½ moon, ¾ moon, and full moon, this would obviously be a unique and uncommon attribute 34 which would normally not be tooled in a supporting application. In addition, another component, such as season, could be introduced to the model, and as the combination of lunar phase is overlaid with the season, it results in a unique visual impact on the CBM map based on the complementing or contradicting effect the components have when integrated. The CBM data visualization tool 26 of the present invention, however, can interpret this information and render the appropriate visual indicators as collected from the data source 22 and present information and indicators in the CBM map 28 which support the moon attribute 34. Furthermore, the CBM data visualization tool 26 can allow users, for example, via the UI 24, to include or exclude one or more of the available attributes 34 at will and in real time, and also alter the coloration of the components 40 to represent a maturity or stage of development for the associated attributes 34 visible across unlimited combinations. The CBM data visualization tool 26 can also host more than one CBM map 28 at a time and provides for the ability to select between different CBM maps 28 to allow for comparison between, for example, different industries, companies, etc.

The CBM data visualization tool 26 can be constructed as a stand alone application which can operate in any browser environment making it an extremely flexible and thin client. The CBM data visualization tool 26 allows the user to navigate over the components and explode them into wide view columns, or windows with all content visible. It also integrates zooming of categories, the ability to scroll within windows, and mouse over display capabilities.

The CBM data visualization tool 26 can be provided, for example, as an applet or a servlet, and can be driven using Java 2 technology (Java and all Java-based trademarks are trademarks of Sun Microsystems, Inc. in the United States, other countries, or both), which provides for an extremely thin and compatible application. The applet is designed to parse out specific pieces of the incoming data to properly configure itself to support the actual information that has been gathered, such as labeling of maps, indicators, components, categories, and attributes. As the user changes source maps which have totally new or unique attributes, the application modifies itself to align with the new map.

The core application can be web based, for example, hosted on a IBM Websphere Application Server 5.0 using Java Server Pages (JSPs). The main JSP folder can contain, for example, the banner, left navigation, tab implementation, meta data, cascading style sheets, JavaScript, service header, page title information, etc., associated with each page. The JSP accepts two request parameters, the view bean which contains the view specific information, and the string representing the JSP. Data imported into the application from external spreadsheets is managed through a maplist table which is imbedded in the applet. It maintains the list of loaded CBMs and their proper content, information, and order along with providing necessary information for dropdown UI selections. This import also places all of the component content and attributes into the proper locations for use in the data visualization. This approach allows the applet to dynamically modify itself to support the constantly changing characteristics of the source data, and never be restricted by predefined options or selections.

The launching of the applet is triggered through a JSP. The griddisplayapplet class is launched and is responsible reading the input file and initializing the swing components used in the applet. Additional classes are triggered which provide the visual display and support repainting during changes.

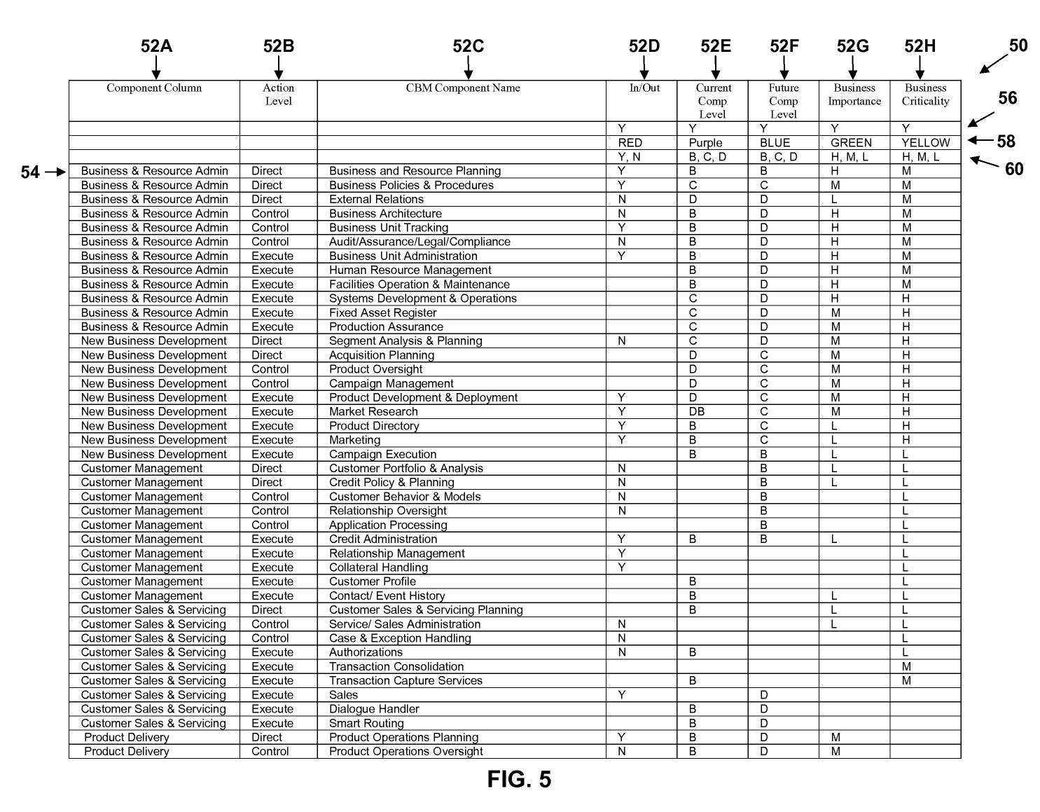

A partial view of an illustrative static data source in the form of a spreadsheet 50 is depicted in FIG. 5. The spreadsheet 50 includes a plurality of columns 52A-H labeled “Component Column,” “Action Level,” “CBM Component Name,” “In/Out,” “Current Comp Level,” “Future Comp Level,” “Business Importance,” and “Business Criticality.” The spreadsheet 50 is provided for descriptive purposes only, and the specific structure and content of the spreadsheet 50 is not intended to be limiting in any way.

In this example, the “Component Column” column 52A lists the names of the columns in a corresponding CBM map 28. The “Action Level” column 52B lists the action level of a corresponding component 40 listed in the “CBM Component Name” column 52C. To this extent, the first two columns 52A-B in each row 54 of the spreadsheet 50 define the position of the component 40 listed in the “CBM Component Name” column 52C in a CBM map 28. The “In/Out,” “Current Comp Level,” “Future Comp Level,” “Business Importance,” and “Business Criticality” columns 52D-H represent the attributes 34 of the components 40. Although only five attributes 34 are shown, any number of attributes 34 can be included in such a spreadsheet 50. Additional rows 54 of the spreadsheet 50 have not been shown for clarity. Further, additional columns 52 of the spreadsheet 50, such as “Component Description,” “Indicative Functionality,” “Called Services,” “Offered Services,” and the like, have also not been shown for clarity.

The row 56 in the spreadsheet 50 is used to designate which of the attributes 34 in columns 52D-H will be displayed in a CBM map 28 (e.g., Y=Yes, N=No). The row 58 in the spreadsheet is used to designate the display color of each of the attributes 34 in columns 52D-H in a CBM map 28 (e.g., red, purple, blue, green, yellow, etc.). Finally, the row 60 in the spreadsheet 50 is used to designate the values that will be displayed in a CBM map 28 for each of the attributes 34 in columns 52D-H (e.g., Y=Yes, N=No; B=Base, C=Competitive, D=Differentiated; H=High, M=Medium, L=Low).

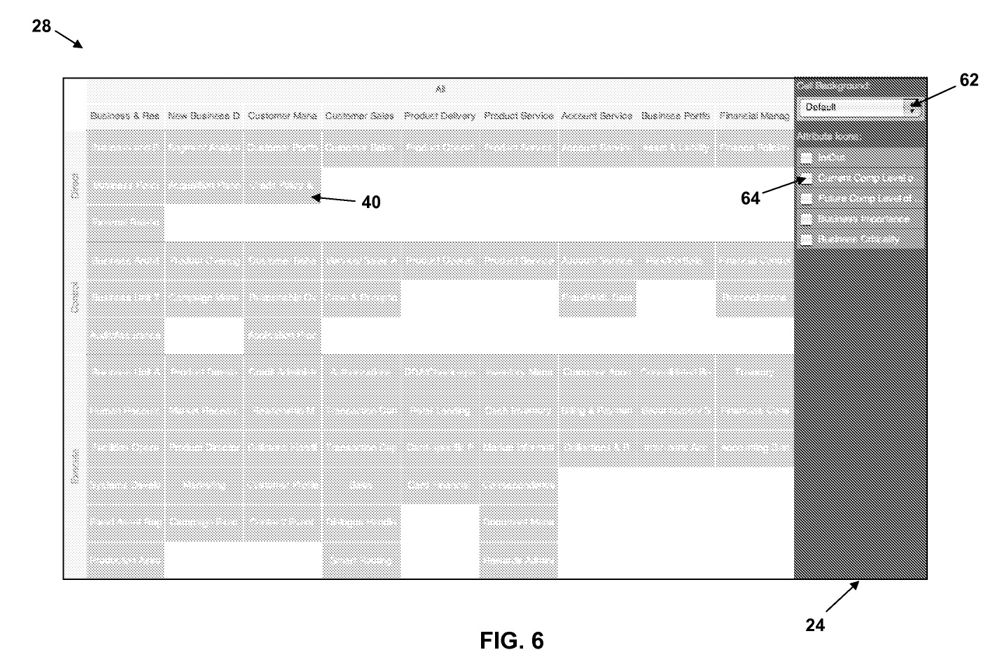

A first example of a CBM map 28 generated by the CBM data visualization tool 26 (FIG. 4) of the present invention using the data provided in the spreadsheet 50 (FIG. 5) is illustrated in FIG. 6. Also shown is an illustrative UI 24, which a user can use to dynamically and interactively control the appearance of the CBM map 28. The UI 24 includes a drop-down menu 62 containing user-selectable cell backgrounds for the components 40 displayed in the CBM map 28, and a plurality of checkboxes 64 for selecting the attribute icons 66 that will be displayed on the CBM map 28. In this example, the drop-down menu 62 includes the selections 64 “Default,” “In/Out,” “Current Comp Level of Capabilities,” “Future Comp Level of Capabilities,” “Business Importance,” and “Business Criticality,” which correspond to the attributes 34 listed in columns 52D-H, respectively, of the spreadsheet 50 in FIG. 5.

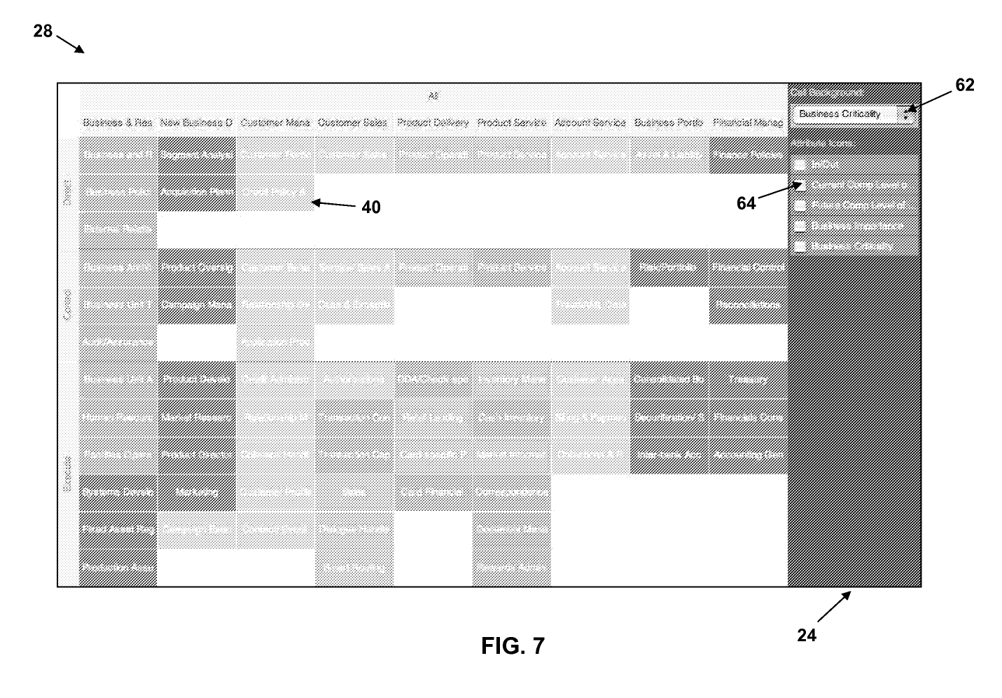

When a selection 64 from the drop-down menu 62 is chosen by a user, the resultant CBM map 28 will include components 40 that have cell backgrounds with thermal indicators (e.g., dark blue, medium blue, light blue, gray, etc.) representing the corresponding values of that attribute 34 in the spreadsheet 50. For example, selection of “Default” from the drop-down menu 62 results in the display of the CBM map 28 shown in FIG. 6. In this case, the cell backgrounds of the components 40 are all gray (i.e., no attributes have been chosen). Selection of “Business Criticality” from the drop-down menu 62, however, results in the display of a different CBM map 28 as shown in FIG. 7. As such, the cell backgrounds of the CBM map 28, which correspond to the values of the attributes 34 in columns 52D-H of the spreadsheet 50, can be easily and quickly changed via the drop-down menu 62.

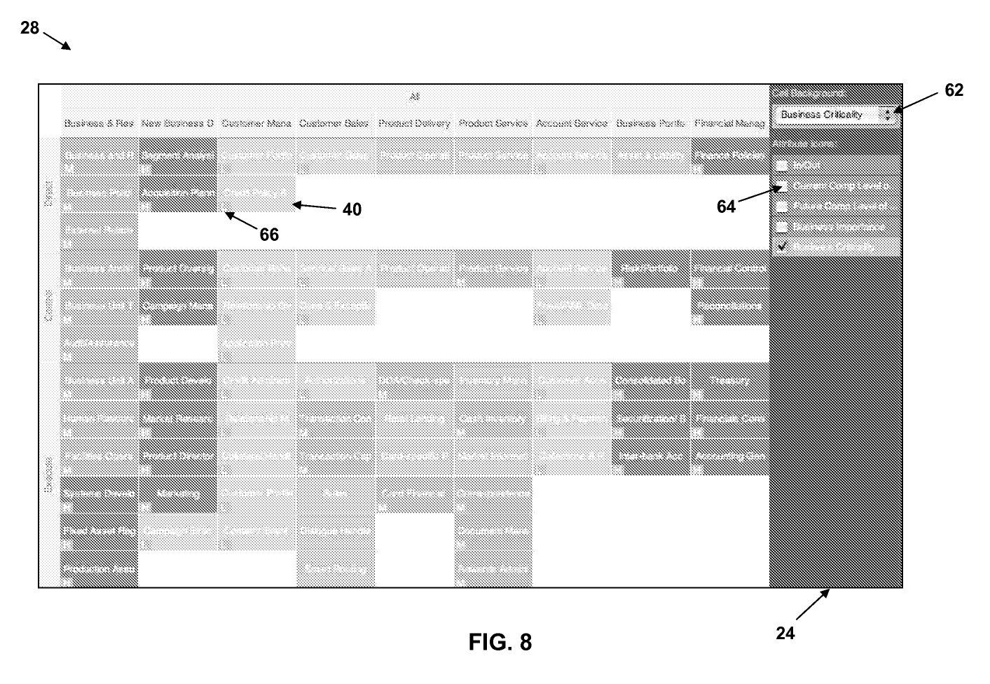

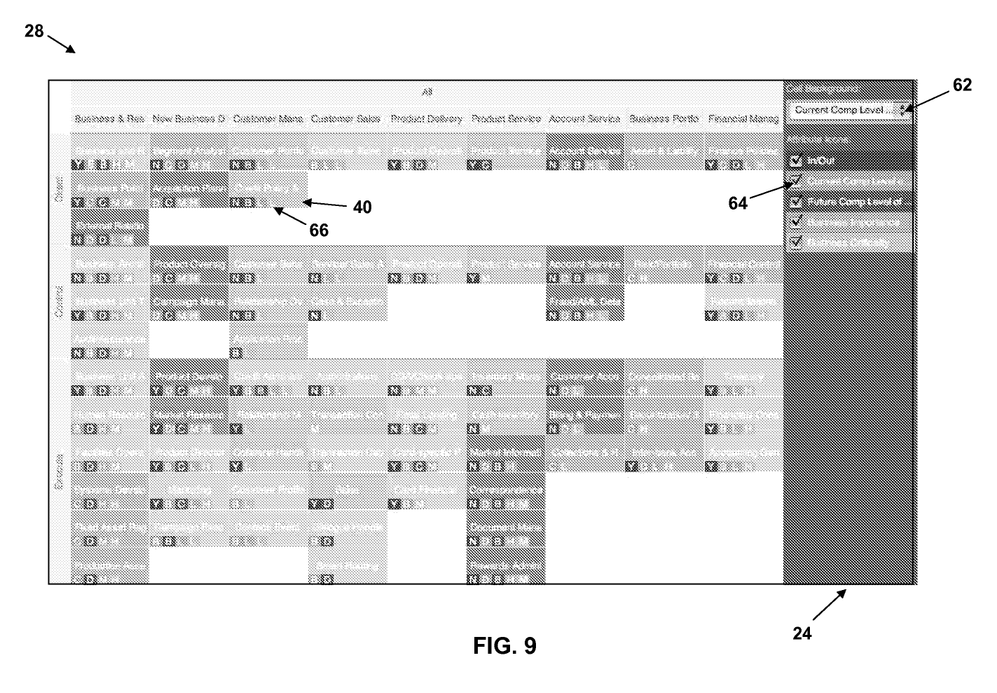

The correspondence between the cell backgrounds of the components 40 in the CBM map 28 and the attribute values in the spreadsheet 50 can be seen more clearly in FIG. 8, where the “Business Criticality” cell background has been selected from the drop-down menu 62 and the attribute icon 66 for “Business Criticality” has been selected by checking the appropriate checkbox 64. In this case, an attribute icon 66, displayed in the color (i.e., yellow) specified in the spreadsheet 50 and designating the value (i.e., H, M, L) of the “Business Criticality” attribute 34, is displayed in the appropriate components 40 of the CBM map 28. Also note that the area around the checkbox 64 for “Business Criticality” is displayed in the same color as the associated attribute icon 66. As shown in FIG. 9, multiple checkboxes 64 can be selected, resulting in the display of a plurality of corresponding attribute icons 66 in the CBM map 28.

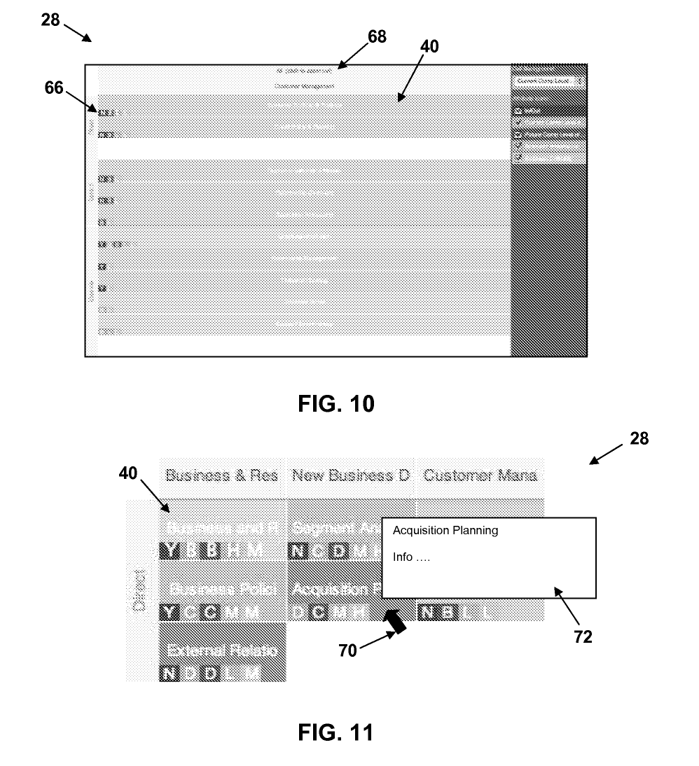

When a user clicks on (or otherwise actuates/selects) a component 40 in the CBM map 28, the column in which the component 40 is located in the CBM map 28 is expanded as shown in FIG. 10. In this case, the user has clicked on a component located in the “Customer Management” column of the CBM map 28 displayed in FIG. 9. The user can return to the full view of the CBM map 28 by actuating the “All (click to zoom out) button 68.

As shown in the partial view of a CBM map 28 in FIG. 11, when the user positions a mouse pointer 70 or other suitable mechanism over a component 40 in the CBM map 28, information regarding that component 40 is displayed in a pop-up window 72. When the mouse pointer 70 is moved off of that component 40, the pop-up window 72 disappears.

The CBM data visualization tool of the present invention can be used to support CBM consultants who need to deploy and communicate the by-product of an CBM engagement. The CBM data visualization tool itself has function and characteristics which allow for a much richer, more sophisticated modeling of CBM information and attributes than standard means (e.g. presentation software, spreadsheets, FLW, etc.) allow. Some general features of the CBM data visualization tool of the present invention include:
a) It can be provided as a web-based application and can be instantly deployed for local disconnected use. Hence, it would be a great support tool (e.g., for sales) to quickly model a customer's business in a sophisticated manner.
b) It can be used at all stages of a CBM engagement to show work in progress.
c) It can be used to display industry and universal maps.
d) It can be used to facilitate a CBM engagement.
e) It can be used as is for quick dashboard enablement (e.g., Metrics, Costs, Revenue, etc,) based on its attribution capability.
f) It allows for graphical rendering of a multitude of information on limited graphic real estate, allows information to be exposed in response to cursor/mouse pass-over, and it supports web based content zoom in and out capabilities to view lower levels of detail.
g) It allows for multiple attributes to be displayed against a chosen CBM backdrop (e.g., cell background).
h) It allows for on screen editing/updates of component names, meta information and attributes.
i) It can support the real time import of XML or CSV files to create new or modified CBM maps.
j) It can support the real time export of XML or CSV files to allow a user to modify the source data and reload it into the CBM data visualization tool for altered visualization.
k) It can support the provision of new attributes. For instance, a user can generate unique attributes within the data source to automatically redefine the filters or selections in the CBM tool. These attributes can be pushed into the CBM tool and displayed with checkboxes or selection.

The CBM data visualization tool of the present invention renders information and supports the ability to display many different aspects of a component, concurrently, without refreshing a view or updating content or data. The CBM data visualization tool can be provided as a stand alone application which can operate in any browser environment making it an extremely flexible and thin client. It allows the user to navigate over components and explode them into wide view columns, or windows with all content visible. The CBM data visualization tool also integrates zooming of categories and the ability to scroll within a window.

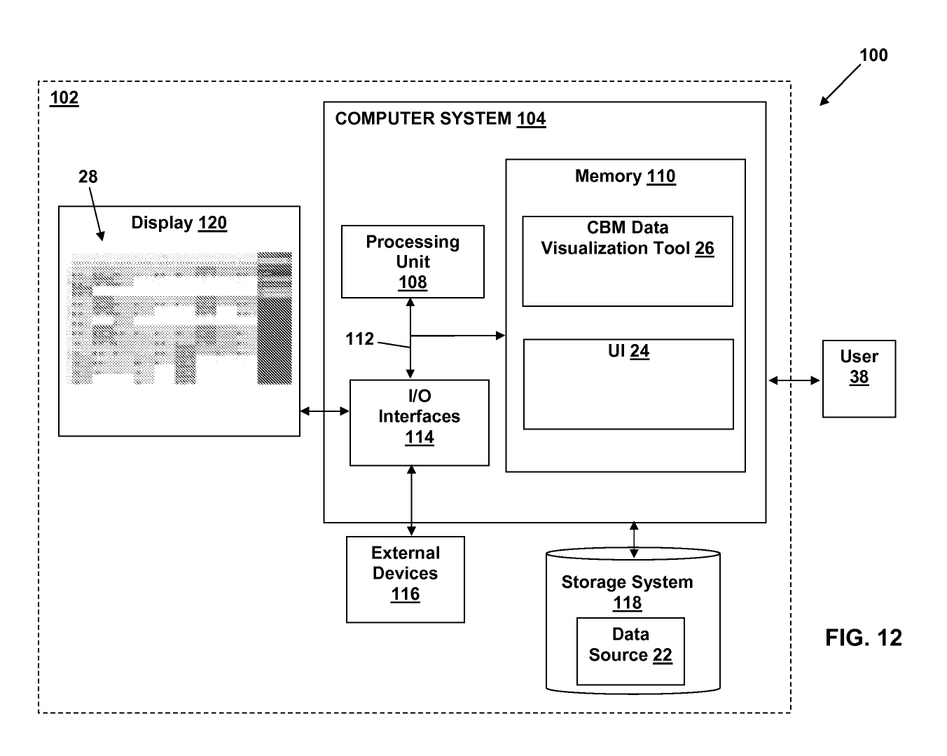

FIG. 12 shows an illustrative system 100 in accordance with embodiment(s) of the present invention. The system 100 includes a computer infrastructure 102 that can perform the various process steps described herein. In particular, the computer infrastructure 102 is shown as including a computer system 104 that comprises an CBM data visualization tool 26, which enables the computer system 104 to generate CBM maps 28 by performing the process steps of the present invention.

The computer system 104 is shown as including a processing unit 108, a memory 110, at least one input/output (I/O) interface 114, and a bus 112. Further, the computer system 104 is shown in communication with at least one external device 116 and a storage system 118. In general, the processing unit 108 executes computer program code, such CBM data visualization tool 26, that is stored in memory 110 and/or storage system 118. While executing computer program code, the processing unit 108 can read and/or write data from/to the memory 110, storage system 118, and/or I/O interface(s) 114. Bus 112 provides a communication link between each of the components in the computer system 104. The external device 116 can comprise any device (e.g., display 120) that enables a user (not shown) to interact with the computer system 104 or any device that enables the computer system 104 to communicate with one or more other computer systems.

The computer system 104 can comprise any general purpose computing article of manufacture capable of executing computer program code installed by a user (e.g., a personal computer, server, handheld device, etc.). However, it is understood that the computer system 104 and the CBM data visualization tool 26 are only representative of various possible computer systems that may perform the various process steps of the invention. To this extent, in other embodiments, the computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, the computer infrastructure 102 is only illustrative of various types of computer infrastructures that can be used to implement the present invention. For example, in one embodiment, the computer infrastructure 102 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, the CBM data visualization tool 26 enables the computer system 104 to generate CBM maps 28. A user 38 can provide input via a UI 24 to control the content, appearance, etc., of the CBM maps 28. The operation(s) carried out by each of these systems is discussed above in greater detail. It is understood that some of the various systems shown in FIG. 12 can be implemented independently, combined, and/or stored in memory for one or more separate computer systems 104 that communicate over a network. Further, it is understood that some of the systems and/or functionality may not be implemented, or additional systems and/or functionality may be included as part of the system 100.

The CBM data visualization tool 26 and UI 24 can be provided as computer program code on a computer-readable medium to enable a computer infrastructure generate CBM maps 28. To this extent, the computer-readable medium includes program code, such as the CBM data visualization tool 26 and UI 24, which implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as the memory 110 and/or storage system 118 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to provide CBM maps 28 in accordance with the present invention. In this case, the service provider can create, maintain, support, etc., a computer infrastructure, such as the computer infrastructure 102, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method for generating CBM maps 28. In this case, a computer infrastructure, such as the computer infrastructure 102, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as the computer system 104, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of the preferred embodiments of this invention has been presented for purposes of illustration and description. It is not intended to be exhaustive or to limit the invention to the precise form disclosed, and obviously, many modifications and variations are possible.

What is claimed is:

1. A method for rendering components in a component business model (CBM) map, comprising:
importing a data set into a CBM visualization tool, the data set providing content and attributes related to the components;
generating and displaying a CBM map based on the content, the CBM map displaying a plurality of the components;
selecting at least one of the attributes via a user interface (UI); and
dynamically displaying information regarding each selected attribute on corresponding components of the CBM map.

2. The method of claim 1, wherein the information regarding each selected attribute comprises an attribute icon.

3. The method of claim 2, wherein the attribute icon displays a value associated with the attribute.

4. The method of claim 2, wherein the attribute icon is color coded.

5. The method of claim 1, further comprising:
displaying the components of the CBM map with thermal indicators.

6. The method of claim 5, further comprising:
selecting the thermal indicators for the CBM map via the UI, wherein the thermal indicators are associated with an attribute.

7. The method of claim 6, wherein the thermal indicators are dependent upon a value associated with the attribute.

8. The method of claim 1, further comprising:
automatically displaying information regarding a component in the CBM map by positioning a pointer on that component.

9. The method of claim 8, wherein the information is displayed in a pop-up window.

10. The method of claim 1, further comprising:
automatically expanding a column in the CBM map by clicking on a component in that column.

11. A system for rendering components in a component business model (CBM) map, comprising:
a system for importing a data set into a CBM visualization tool, the data set providing content and attributes related to the components;
a system for generating and displaying a CBM map based on the content, the CBM map displaying a plurality of the components;
a user interface (UI) for selecting at least one of the attributes; and
a system for dynamically displaying information regarding each selected attribute on corresponding components of the CBM map.

12. The system of claim 11, wherein the information regarding each selected attribute comprises an attribute icon.

13. The system of claim 12, wherein the attribute icon displays a value associated with the attribute.

14. The system of claim 12, wherein the attribute icon is color coded.

15. The system of claim 11, further comprising:
a system for displaying the components of the CBM map with thermal indicators.

16. The system of claim 15, further comprising:
a UI for selecting the thermal indicators for the CBM map, wherein the thermal indicators are associated with an attribute.

17. The system of claim 16, wherein the thermal indicators are dependent upon a value associated with the attribute.

18. The system of claim 11, further comprising:
a system for automatically displaying information regarding a component in the CBM map by positioning a pointer on that component.

19. The system of claim 18, wherein the information is displayed in a pop-up window.

20. The system of claim 11, further comprising:
a system for automatically expanding a column in the CBM map by clicking on a component in that column.

21. A program product stored on a computer readable medium for rendering components in a component business model (CBM) map, the computer readable medium comprising program code for:
importing a data set into a CBM visualization tool, the data set providing content and attributes related to the components;
generating and displaying a CBM map based on the content, the CBM map displaying a plurality of the components;
selecting at least one of the attributes via a user interface (UI); and
dynamically displaying information regarding each selected attribute on corresponding components of the CBM map.
